(19) United States
(12) Patent Application Publication
(10) Pub. No.: US 2015/0092064 A1
(43) Pub. Date: Apr. 2, 2015

(54) Recording Device Positioner Based on Relative Head Rotation

(71) Applicant: Carlo Antonio Sechi, Houston, TX (US)

(72) Inventor: Carlo Antonio Sechi, Houston, TX (US)

(21) Appl. No.: 14/464,523

(22) Filed: Aug. 20, 2014

Related U.S. Application Data
(60) Provisional application No. 61/884,071, filed on Sep. 29, 2013.

(51) Int. Cl. H04N 5/232; H04N 5/225

(52) U.S. Cl. CPC H04N 5/23222; H04N 5/2251; H04N 5/23296
USPC 348/169

(57) ABSTRACT

In one aspect, a recording device positioner is provided. The recording device includes a base having a connection portion that is configured to receive a recording device. The recording device positioner further includes a positioning sensor configured to sense the movement of a user. Additionally, the recording device positioner includes a motor attached to the base, the motor being configured to rotate the recording device relative to the base based upon signals sent by the positioning sensor. In another aspect, a method of recording a desired area of interest using a recording device positioner is provided. In a further aspect, a device positioner for moving a video recording device based on movements of a user is provided.

### CROSS-REFERENCE TO RELATED APPLICATIONS

This application claims benefit of U.S. Provisional Patent Application having Ser. No. 61/884,071 filed on Sep. 29, 2013. The entirety of the provisional patent application is incorporated herein by reference.

### BACKGROUND

1. Field of the Invention

Embodiments of the invention relate to video recording. More specifically, embodiments of the invention relate to a video recording device positioner based on relative head rotation.

2. Description of the Related Art

As known in the video recording industry, there are many forms of devices for the recording of motion video, such as video cameras, smart phones, and tablet computers. However, these devices require the user to hold or manually position the camera to capture the desired area of interest. In some recording situations, the user may have the device pointed in a first direction while the user is visually viewing the desired area of interest in a second direction. Therefore, there is a need for a device positioner that is capable of movement based on relative head rotation of the user.

### BRIEF SUMMARY OF THE PRESENT INVENTION

In one aspect, a recording device positioner is provided. The recording device includes a base having a connection portion that is configured to receive a recording device. The recording device positioner further includes a positioning sensor configured to sense the movement of a user. Additionally, the recording device positioner includes a motor attached to the base, the motor being configured to rotate the recording device relative to the base based upon signals sent by the positioning sensor.

In another aspect, a method of recording a desired area of interest using a recording device positioner is provided. The recording device positioner has a position sensor and a base configured to receive a recording device. The method includes the step of attaching the positioning sensor to a body portion of a user. The method also includes the step of inputting a zero reference direction of the recording device positioner. Additionally, the method includes the step of rotating the recording device relative to the based upon signals sent by the positioning sensor.

In a further aspect, a device positioner for moving a video recording device based on movements of a user is provided. The device positioner includes a base. The device positioner further includes a positioning sensor configured to be attached to a body portion of the user and sense the movement of the user. The device positioner also includes a rotation member disposed in the base, the rotation member being configured to rotate the video recording device relative to the base. Additionally, the rotation member includes a microcontroller configured to receive signals from the positioning sensor and to send control signals to the rotation member.

### BRIEF DESCRIPTION OF THE DRAWINGS

The invention may best be understood by referring to the following description and accompanying drawings that are used to illustrate embodiments of the invention. In the drawings:

FIG. 1 shows a perspective view of a video recording positioner according to one embodiment.

FIG. 2 illustrates ranges of rotation of a base in the video recording positioner.

FIG. 3 illustrates the operational flow logic of the video recording positioner.

FIG. 4 is a schematic of the basic operational principles of the video recording positioner.

FIG. 5 is a flow chart illustrating the procedure routine of the video recording positioner.

### DETAILED DESCRIPTION

Generally, filming of video has traditionally required the viewer to position a video recording device manually to capture the area of interest. This invention provides a motorized video recording device positioning system which utilizes the relative rotation of the viewers head position to rotate the field of view of the video recording device.

The use of gyroscopes, accelerometers, tilt sensors, and compass devices have been used in radio controlled and unmanned vehicles to determine directional heading. These sensors are used together to provide a compass heading direction which does not vary based on the tilt of the sensor in the pitch and yaw directions. The present invention seeks to utilize the sophisticated directional heading and movement sensors to position a video camera corresponding to the relative rotation of the user's head about the spine axis. To better understand the aspects of the invention, the invention will be described in relation to the following figures.

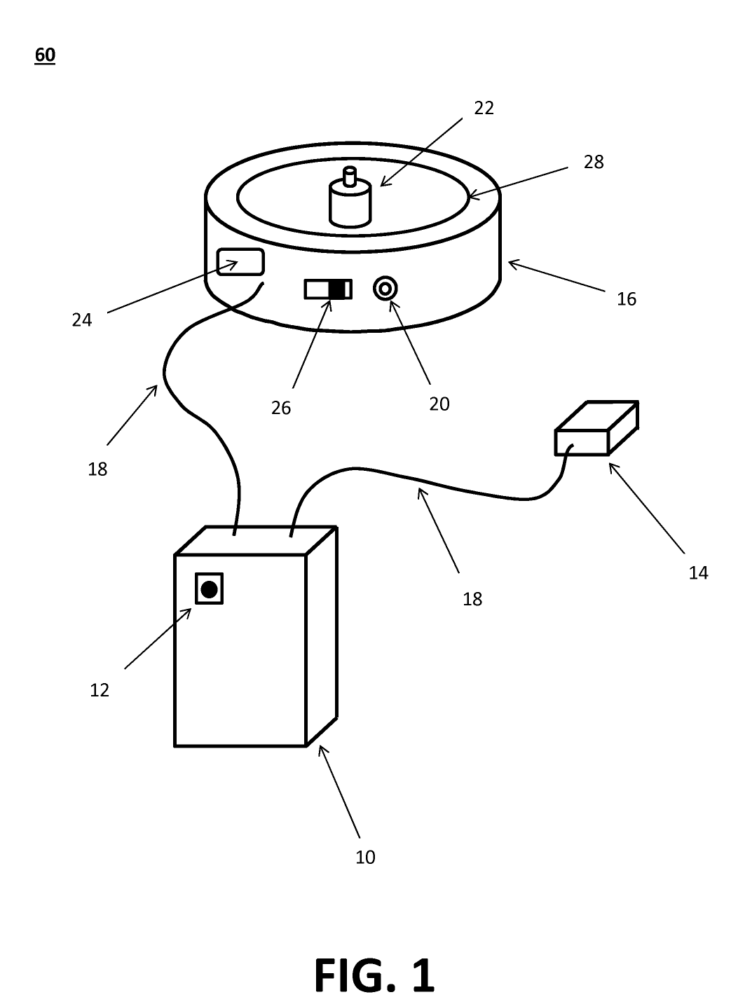

FIG. 1 shows a perspective view of a video recording positioner 60 according to one embodiment. The positioner includes a base 16 having a rotating platform 28 which allows movement about a fixed axis. A camera may be attached to the rotating platform 28. In one embodiment, the rotating platform 28 may include the camera. In another embodiment, a connection portion may be provided on the rotating platform 28 to support a camera, mobile device, smart phone, tablet computer, or other recording device. In another embodiment, the device may be utilized with a still photography camera. Connection of the devices to the rotating platform 28 may include a connection member such as screws, a cradle, or fasteners similar to Velcro.

The rotating platform 28 may be connected to the base 16 by a rotation member such as motor 22. The motor 22 may be a servo motor similar to a Hitec HS-55. The motor 22 may also be a stepper motor or a magnetic movement device. A power supply 24 may provide the power needed for the video recording positioner 60. The power supply 24 may be a DC battery. A power switch 26 may control the on/off state of the video recording positioner 50.

The base 16 may be provided with a connection point to allow mounting to a traditional camera tripod. The base 15 may also be handheld, connected to a handle, connected to a body attachment device, or to a specialized bracket. When filming an event, it may be necessary to restrict the limits of rotation of the rotating platform 28 to limit the rotation of the camera. A range of travel setting 20 is used to reduce the rotational range of the rotating platform 28. The range of travel setting 20 may be a potentiometer.

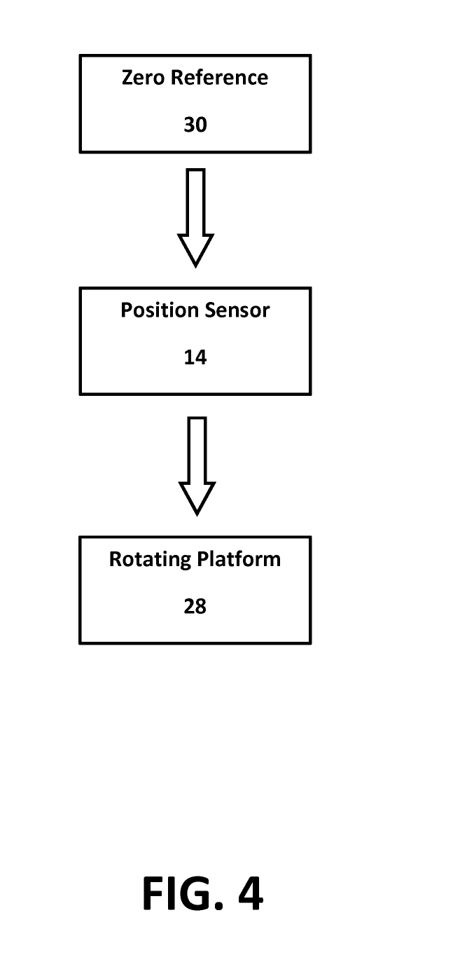

FIG. 4 is a schematic of the basic operational principles of the video recording positioner 60. A zero reference direction 30 is first established by the user from which a position sensor 14 measures the rotation of the user's head about the spine axis and thereby moves the rotating platform 28. The position sensor 14 may be a Devantech CMPS10. The position sensor 14 may include an accelerometer, tilt sensor, or magnetometer. The positioning of the rotating platform 28 is based on the relative movement of the user's head. To determine the center and starting reference point, the user depresses the zero reference button 12 to establish the zero reference direction 30. The position sensor 14 may be attached to a bracket which allows the user to wear the sensor on the ear. In another embodiment, the position sensor 14 may be attached to an article of clothing worn by the user, such as a shirt, a hat, visor, or glasses. In other embodiment, the position sensor 13 may connect to the user's body to detect relative rotational change and may include such parts as the user's shoulder, arm, or chest. The position sensor 14 may connect to the base 16 utilizing flexible wiring 18. In another embodiment, wireless communication may also be used and may include radio frequency signals, infrared, or Bluetooth signals that would allow the user to be physically separated from the base 16, thereby allowing the base to be located at an optimal recording location which may differ from the user's location.

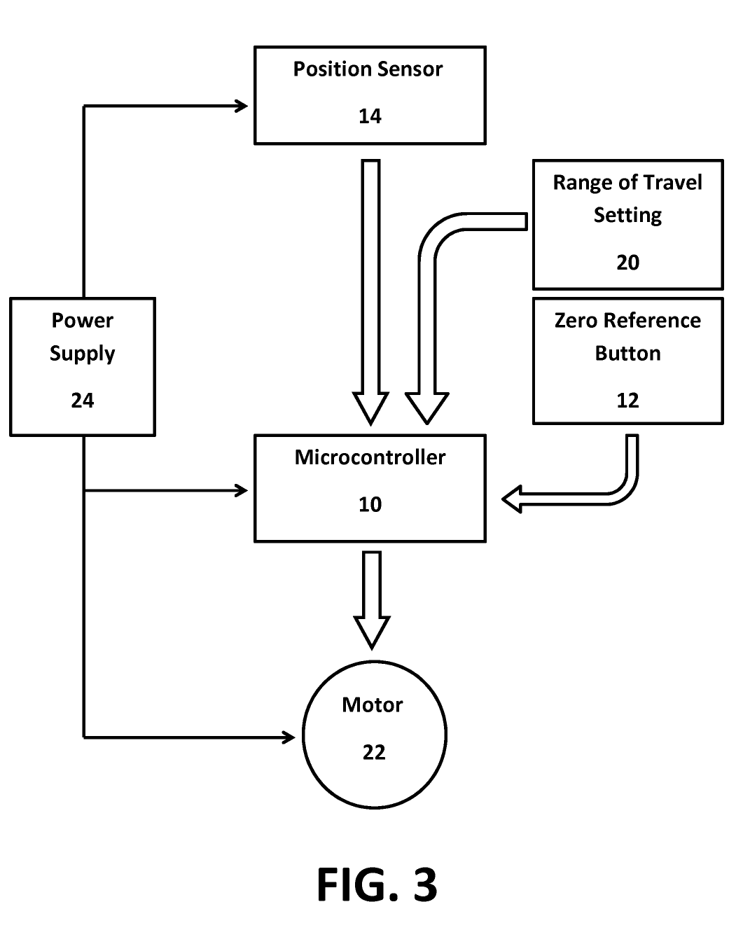

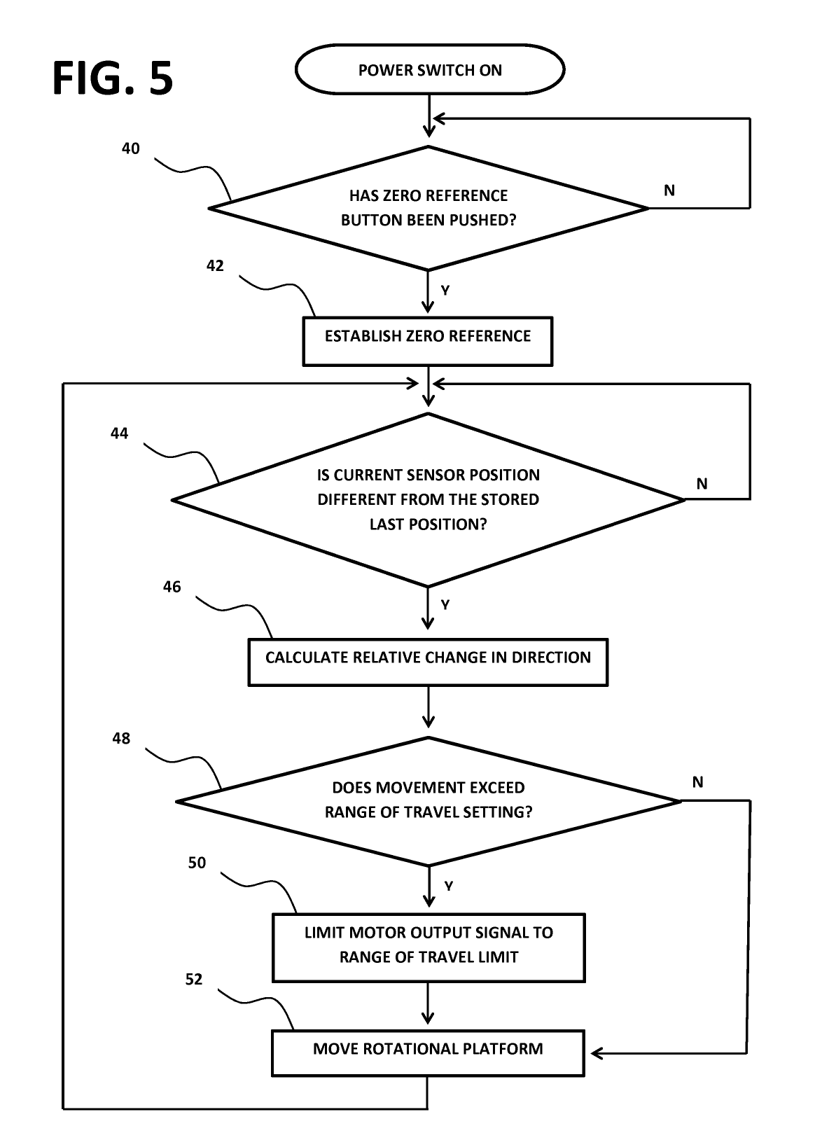

Referring back to FIG. 1, the video recording positioner 60 may also include a microcontroller 10. The microcontroller 10 can be chosen from any number of commercially available products which include a central processing unit, random access memory (RAM), and input/output (I/O) ports similar to a Parallax Propeller. The microcontroller 10 may be separate as shown in FIG. 1 or in another embodiment may be incorporated to be included within the packaging of the positioning base 16, for example located embedded in the base below the rotating platform 28. In another embodiment the microcontroller 10 may be incorporated within the packaging of the position sensor 14, for example contained within the ear piece worn by the user. An alternate improvement may include the use of a smartphone, laptop, or mobile computing device in lieu of the microcontroller 10 to perform the operational flow logic identified in FIGS. 3 and 5. In another embodiment, a smartphone or similar device application may provide a user interface to the video recording positioner 60 which may include allowing the user to input and change the range of travel setting 20 and establish the zero reference button 12 input to the system.

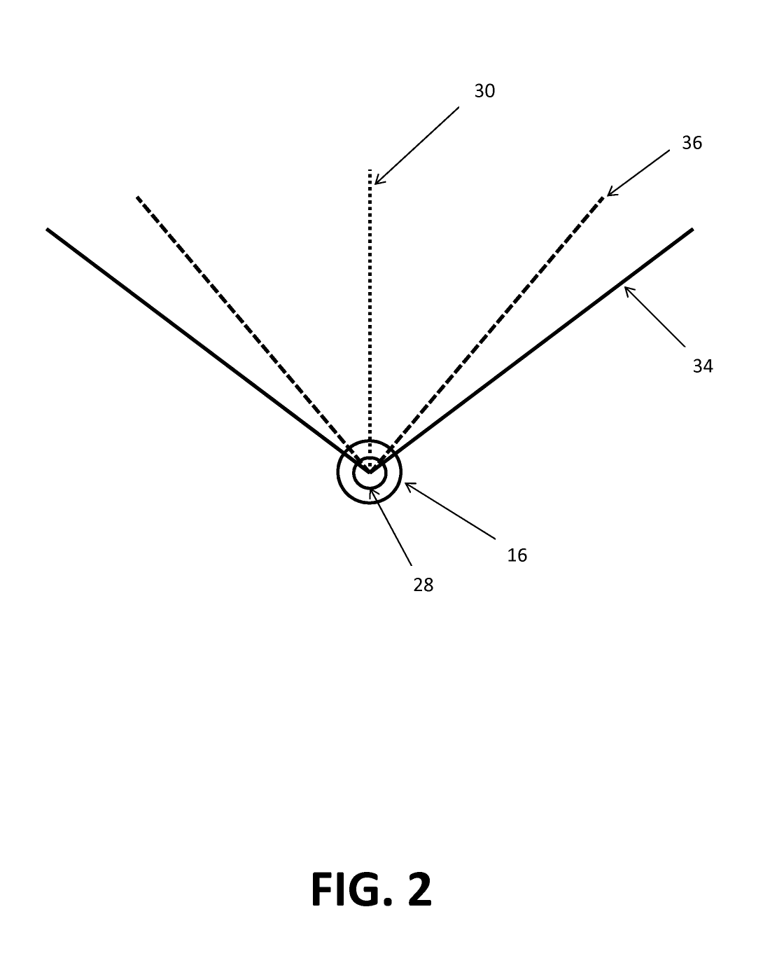

FIG. 2 is a top view of the base 16 indicating the ranges of rotation. The zero reference direction is indicated in FIG. 2 as reference number 30. This zero reference direction 30 is established when the user presses the zero reference button 12 (see FIG. 1). The full range of travel of movement for the rotating platform 28 is identified as reference number 34. This is the full rotational range of the rotating platform 28. The range of movement can be limited by the user by adjusting the range of travel setting 20. The range of travel can be limited to a range less than the full range, as shown by reference number 36.

FIG. 3 depicts the operational flow logic of the video recording positioner 60. With the power supply 24 providing power to the system through the on/off switch 26 the microcontroller 10 waits for the depression of the zero reference button 12 to establish the zero reference direction 30. The position sensor 14 measures the head rotational movement of the user and provides this information to the microcontroller 10 to determine the change of rotation of the user's head from the zero reference direction 30. The range of travel setting 20 provides an input to the microcontroller 10 to limit the range of rotation of the rotating platform 28. As the position sensor 14 input changes from the zero reference heading 30 the microcontroller 10 outputs a position movement to the motor 22 proportional to the change in heading. The microcontroller 10 monitors the range of travel setting 20 to establish the limits of rotation of the motor 22. The microcontroller 10 limits the output to the motor 22 in order not to exceed the calculated limits of rotation of the motor 22.

When the power switch 26 is enabled to allow power to the video recording positioner 60, the microcontroller 10 starts the routine in FIG. 5, and advances to decision block 40 to determine if the zero reference button 12 has been pressed and if it has not it loops back as shown. If it is determined that the zero reference button 12 has been pressed, the routine proceeds to block 42 wherein it establishes the zero reference direction 30 as the current positional output from the position sensor 14, outputs a signal to motor 22 directing it to move the rotational platform 28 to the center position, stores the positional output in the memory of the microprocessor 10 as the last positional reading, and then proceeds to decision block 44. At decision block 44, the microprocessor 10 determines whether the current positional output from the position sensor 14 is different from the last stored positional reading. If a difference is identified, the microcontroller 10 calculates the output signal for the motor 22, stores the positional output in the memory of the microprocessor 10 as the last positional reading, and proceeds to decision block 48. At decision block 48 it is determined whether the calculated output signal for the motor exceeds the range of travel limit 36 and proceeds to block 50 if it is affirmative. If it is not, then the routine proceeds to block 52 and outputs the signal to the motor 22 to move the rotational platform 28. At block 50, the microcontroller 10 limits the output to the motor 22 to the range of travel limit 36 and proceeds to block 52 where this limited signal is outputted to motor 22. The routine operates in a continual loop, returning to decision block 44.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A recording device positioner comprising:
a base having a connection portion that is configured to receive a recording device;
a positioning sensor configured to sense the movement of a user; and
a motor attached to the base, the motor being configured to rotate the recording device relative to the base based upon signals sent by the positioning sensor.

2. The recording device positioner of claim 1, wherein the positioning sensor is selected from the group consisting of an accelerometer, tilt sensor, or magnetometer.

3. The recording device positioner of claim 1, wherein the positioning sensor is configured to be attached to a body portion of the user.

4. The recording device positioner of claim 1, wherein the positioning sensor is configured to be attached to a head of the user.

5. The recording device positioner of claim 1, wherein the positioning sensor is configured to be attached to an article of clothing worn by body the user.

6. The recording device positioner of claim 1, further comprising a microcontroller being configured to receive signals from the positioning sensor and to send control signals to the motor.

7. The recording device positioner of claim 6, wherein the microcontroller and the positioning sensor are an integral unit.

8. The recording device positioner of claim 6, wherein the microcontroller is a smartphone, a laptop, or a mobile computing device.

9. The recording device positioner of claim 1, further comprising a power source configured to provide power to the motor.

10. The recording device positioner of claim 1, further comprising a zero reference button that is connected to the positioning sensor.

11. The recording device positioner of claim 10, wherein the zero reference button is used by the user to establish a zero reference direction.

12. A method of recording a desired area of interest using a recording device positioner, the recording device positioner having a position sensor and a base configured to receive a recording device, the method comprising:
attaching the positioning sensor to a body portion of a user;
inputting a zero reference direction of the recording device positioner; and
rotating the recording device relative to the based upon signals sent by the positioning sensor.

13. The method of claim 12, further comprising calculating a relative change in direction of the user in relation to the zero reference direction.

14. The method of claim 13, wherein a smartphone, a laptop, or a mobile computing device calculates the relative change in direction based upon signals sent by the positioning sensor.

15. The method of claim 12, further comprising determining a range of travel of the rotation of the recording device positioner.

16. A device positioner for moving a video recording device based on movements of a user, the device comprising:
a base;
a positioning sensor configured to be attached to a body portion of the user and sense the movement of the user;
a rotation member disposed in the base, the rotation member being configured to rotate the video recording device relative to the base; and
a microcontroller configured to receive signals from the positioning sensor and to send control signals to the rotation member.

17. The device positioner of claim 16, wherein the microcontroller and the positioning sensor are an integral unit.

18. The device positioner of claim 16, wherein the positioning sensor is selected from the group consisting of an accelerometer, tilt sensor, or magnetometer.

19. The device positioner of claim 16, wherein the microcontroller is a smartphone, a laptop, or a mobile computing device.

20. The device positioner of claim 16, further comprising a power source configured to provide power to the rotation member.
